(19) United States
(12) Patent Application Publication
(10) Pub. No.: US 2025/0178983 A1
(43) Pub. Date: Jun. 5, 2025

(54) COMPLEXING AGENT FOR PROMOTING DECOMPOSITION OF LOQUAT LEAF LITTER

(71) Applicant: Ministry of Ecology and Environment Center for Satellite Application on Ecology Environment, BEIJING (CN)

(72) Inventors: JIXI GAO, BEIJING (CN); HUAYUE NIE, BEIJING (CN); XIAOMAN LIU, BEIJING (CN); BIAO ZHANG, BEIJING (CN); CHENRUI WANG, BEIJING (CN); PENG HOU, BEIJING (CN); ZHONGJIE SHI, BEIJING (CN); YANMEI CHEN, BEIJING (CN); ZHONGFEI LI, BEIJING (CN); SHUYING BAI, BEIJING (CN); HANZHI LI, BEIJING (CN); CHAO WANG, BEIJING (CN); NA LV, BEIJING (CN); QIAN ZHOU, BEIJING (CN); ZHUO FU, BEIJING (CN)

(21) Appl. No.: 18/959,914

(22) Filed: Nov. 26, 2024

(30) Foreign Application Priority Data
Nov. 30, 2023 (CN) 202311622726.4

(51) Int. Cl. C05F 17/20; C05F 5/00

(52) U.S. Cl. CPC C05F 17/20; C05F 5/002; C12Y 111/01014; C12Y 304/11001

(57) ABSTRACT

The present invention discloses a complexing agent for promoting decomposition of loquat leaf litter, which belongs to the technical field of plant science. According to the present invention, the mixed solution of Pseudomonas solution, lignin peroxidase, and leucine aminopeptidase solution is applied to the loquat leaf litter, and after in-situ decomposition for four months, the mass loss rate and the decomposition constant of the loquat leaf litter are significantly increased, thereby effectively promoting the decomposition of the loquat leaf litter. The present invention first proposes that the decomposition of the loquat leaf litter is influenced by externally applying a combination agent of enzyme and bacterial solution, which is simple in operation, and promotes the decomposition of the loquat leaf litter while increasing the speed of returning organic matters to soil, thereby improving soil fertility.

### TECHNICAL FIELD

The present invention relates to the technical field of plant science, more particularly to a complexing agent for promoting decomposition of loquat leaf litter.

### BACKGROUND

Litter is a generic term of all organic matters that are generated from above-ground components of plants and returned to a ground surface in an ecosystem, which are used as a source of matter and energy for decomposing agents to maintain ecosystem functions. Forest litter decomposition is a main way to transfer carbon and nutrient elements from plants to soil, and is an important link of matter cycle and energy flow in the ecosystem. It plays an important role in maintaining soil fertility and promoting normal matter cycle and nutrient balance of a forest ecosystem. The essence of litter decomposition is an enzymatic hydrolysis process of microorganisms under the systematic action of litter enzyme and soil enzyme. The increase in enzyme activity is beneficial to the decomposition of litter and the release of the nutrient elements.

Loquat is one of the preferred varieties in economic orchards in South China. In the process of planting, the trimmed loquat leaf litter occupies a large area and decomposes slowly. At present, the treatment of the loquat leaf litter mainly includes natural decomposition or manual cleaning for unified treatment as agricultural waste. However, long-term accumulation affects soil respiration and orchard planting, and even causes agricultural non-point source pollution. Manual cleaning requires high cost, which reduces the economic value of the orchards.

Therefore, the research of effective measures to accelerate the decomposition of the loquat leaf litter is of great practical significance to reduce agricultural pollution, control planting cost, improve the soil fertility and enhance the soil carbon sink function. It is an urgent need to find a method for promoting litter decomposition, so as to properly solve agricultural waste while improving the soil fertility.

When promoting the litter decomposition, it is necessary to ensure that the components used are green and environmentally friendly, and non-corrosive, and do not pollute the soil or harm the plant roots and forestland shrub layers. Therefore, when selecting materials, only biological agents such as enzymes, bacteria and fertilizers are optional after corrosive chemical reagents are excluded. Screening suitable components in so many biological agents and optimizing a best ratio require constant exploration and improvement.

To sum up, the problem to be urgently solved by those skilled in the art is to provide a decomposing agent for promoting the decomposition of the loquat leaf litter.

### SUMMARY

In view of this, the present invention provides a complexing agent for promoting decomposition of loquat leaf litter. The present invention first proposes the method of externally applying enzyme solution and bacterial solution to accelerate the decomposition rate of the loquat leaf litter and promote the return of organic matters in the loquat leaf litter to soil, thereby enhancing the soil nutrients and the carbon sink function thereof.

The present invention aims to solve the problem of a large amount of waste, i.e., loquat leaf litter, produced in agricultural planting, so as to accelerate the decomposition of the loquat leaf litter to promote the return of nutrients in the loquat leaf litter and improve the soil nutrients.

To achieve the above purpose, the present invention adopts the following technical solutions:

A complexing agent for promoting decomposition of loquat leaf litter comprises leucine aminopeptidase, lignin peroxidase, and Pseudomonas solution, and a mass-to-volume ratio of leucine aminopeptidase, lignin peroxidase, and Pseudomonas solution is (5-15) kg:(5-15) kg:(5-15) ml.

The beneficial effects achieved are: Leucine aminopeptidase converts amino acid at the nitrogen terminal of polypeptide into leucine, which is an important invertase of soluble organic matters, and the activity thereof is closely related to the content of nitrogen and phosphorus in the litter. Lignin is a refractory substance in the loquat leaf litter, and the late decomposition rate of the loquat leaf litter is affected by ligninase. Bacteria and fungi become the main decomposing agents of the forest litter because they can decompose lignin, cellulose and other components that are difficult to be degraded by other microorganisms. Pseudomonas has the function of decomposing cellulose efficiently.

Further, a complexing agent for promoting decomposition of loquat leaf litter comprises leucine aminopeptidase, lignin peroxidase, and Pseudomonas solution, and a mass-to-volume ratio of leucine aminopeptidase, lignin peroxidase, and Pseudomonas solution is 10 kg:15 kg:10 ml.

Further, a complexing agent for promoting decomposition of loquat leaf litter comprises leucine aminopeptidase, lignin peroxidase, and Pseudomonas solution, and a mass-to-volume ratio of leucine aminopeptidase, lignin peroxidase, and Pseudomonas solution is 5 kg:5 kg:5 ml.

Further, the enzyme activity of leucine aminopeptidase and lignin peroxidase is greater than or equal to 20 units/mg.

A method for promoting decomposition of loquat leaf litter applies the above decomposing agent.

Further, the method comprises the following steps:
(1) dissolving leucine aminopeptidase and lignin peroxidase in water to obtain mixed enzyme solution;
(2) dissolving Pseudomonas solution in water to obtain bacteria diluent;
(3) spraying the mixed enzyme solution and the bacteria diluent on a surface of loquat leaf litter, and decomposing in a natural environment for four months.

Further, the application amount of the leucine aminopeptidase is 5-15 mg/g litter;

The application amount of the lignin peroxidase is 5-15 mg/g litter;

The application amount of the Pseudomonas solution is 5-15 μl/g litter.

Further, the mass-to-volume ratio of the leucine aminopeptidase to the water is 1:500 g/ml;

The mass-to-volume ratio of the lignin peroxidase to the water is 1:500 g/ml;

The volume ratio of the Pseudomonas solution to the water is 1:1000.

Further, the natural environment is: a daytime temperature of 15±5° C., with a humidity of 75±5%; a nighttime temperature of 5±3° C., with a humidity of 40±5%.

It can be seen from the above technical solution that compared with the prior art, the present invention has the following beneficial effects: through a practical research on spraying of the mixed solution of enzyme and bacteria (including Pseudomonas, lignin peroxidase, and leucine aminopeptidase) on the loquat leaf litter, it is found that after spraying the mixed solution of enzyme and bacteria on the surface of the loquat leaf litter and continuously decomposing for four months, both the decomposition constant and the mass loss rate of the loquat leaf litter are improved. The present invention can effectively solve the problem that the loquat leaf litter is difficult to be treated as agricultural waste, thereby reducing agricultural pollution. At the same time, the return of the nutrients in the loquat leaf litter is promoted, and the soil nutrients are improved. Moreover, the method of the present invention has the advantages of simple operation and green environmental protection.

### DESCRIPTION OF DRAWINGS

To more clearly describe the technical solutions in the embodiments of the present invention or in the prior art, the drawings required to be used in the description of the embodiments or the prior art will be simply presented below. Apparently, the drawings in the following description are merely the embodiments of the present invention, and for those ordinary skilled in the art, other drawings can also be obtained according to the provided drawings without contributing creative labor.

FIG. 1 is a diagram for an in-situ decomposition test of the present invention.

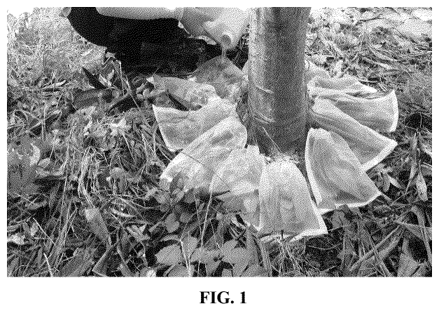

### DETAILED DESCRIPTION

The technical solutions in the embodiments of the present invention will be clearly and fully described below in combination with the drawings in the embodiments of the present invention. Apparently, the described embodiments are merely part of the embodiments of the present invention, not all of the embodiments. Based on the embodiments in the present invention, all other embodiments obtained by those ordinary skilled in the art without contributing creative labor will belong to the protection scope of the present invention.

In the present invention, Pseudomonas solution, lignin peroxidase, and leucine aminopeptidase have no special models. The products commonly available on the market can be used.

### Embodiment 1

Initial physical and chemical properties of loquat leaf litter

The initial physical and chemical indicators (total carbon, total nitrogen, total potassium, cellulose content, and lignin content) of the loquat leaf litter were measured, with the results as shown in Table 1.

TABLE 1
Initial Physical and Chemical Properties of Loquat Leaf Litter

| | Total | Total | Total | | |
|---|---|---|---|---|---|
| | carbon | nitrogen | potassium | Cellulose | Lignin |
| | (g/kg) | (g/kg) | (g/kg) | (%) | (%) |
| Loquat leaf litter | 464 | 16.5 | 14 | 19 | 24 |

### Embodiment 2

Research on effects of laccase, lignin peroxidase and leucine aminopeptidase on decomposition of loquat leaf litter

A single enzyme (with a concentration of 10 mg/g litter) was applied to the surface of the loquat leaf litter. The application mode was to dissolve the enzyme in water to prepare enzyme solution, then spray the enzyme solution evenly on the surface of the loquat leaf litter (wherein the mass-to-volume ratio of enzyme to water was 1:500 g/ml), decompose for 117 days in a constant temperature and humidity environment (an incubator: temperature of 35° C., and humidity of 75%), measure the mass of the loquat leaf litter before and after the deposition, and calculate the mass loss rate and the decomposition constant.

The mass residual rate was calculated using the following formula:

$${M}_{R} = {M}_{t} / {M}_{0} \times 100 \% \qquad ( 1 )$$

where: M_{R} indicates the mass residual rate, M₀ indicates the initial mass of litter (g), and Mₜ indicates the residual mass (g) after litter is decomposed at time t.

$$Mass loss rate = 1 - mass residual rate \qquad ( 2 )$$

The decomposition rate was calculated using an Olson negative exponential decay model:

$$y = {e}^{- kt} \qquad ( 3 )$$

where: t indicates the time (day), y indicates the mass residual rate at t, and k indicates the decomposition constant.

The results were shown in Table 2.

TABLE 2
Effects of Different Enzymes on Decomposition
of Loquat Leaf Litter

| | | Mass | Decomposition |
|---|---|---|---|
| Group | Treatment method | loss rate | constant |
| Experimental | Applying laccase | 28.20% | 0.0028 |
| Group 1 | | | |
| Experimental | Applying lignin peroxidase | 30.94% | 0.0032 |
| Group 2 | | | |
| Experimental | Applying leucine | 34.00% | 0.0033 |
| Group 3 | aminopeptidase | | |
| Control | Applying water | 23.68% | 0.0023 |
| Group 1 | | | |

The results showed that compared with the control group 1, the mass loss rates in the experimental groups 1-3 were higher, and P was less than 0.05, which indicated that the mass loss rate of the loquat leaf litter could be significantly improved in the experimental groups 1-3. Compared with the control group 1, the decomposition constants in the experimental groups 1-3 were also significantly improved. That is: the solutions of the experimental groups 1-3 could significantly promote the decomposition of the loquat leaf litter. Wherein the solution of applying leucine aminopeptidase has the best effect in promoting decomposition, and the mass loss rate is increased by 10.32% compared with the control group 1. The mass loss rate is increased by 4.52% and 7.26% respectively by applying laccase and lignin peroxidase compared with the control group 1, which also has obvious effect in promoting decomposition.

To sum up, the decomposition of the loquat leaf litter could be significantly promoted by applying the lignin peroxidase solution, the leucine aminopeptidase solution, and the laccase solution to the loquat leaf litter, and decomposing for 117 days.

### Embodiment 3

Effects of nitrogen fertilizer, phosphorus fertilizer and trace element fertilizer on decomposition of loquat leaf litter

A single fertilizer (nitrogen fertilizer, phosphorus fertilizer, and trace element fertilizer) (with a concentration of 50 mg/g litter) was applied to the surface of the loquat leaf litter. The application method was to dissolve the fertilizer in water to prepare a fertilizer solution, then spray the fertilizer solution evenly on the surface of the loquat leaf litter (wherein the mass-to-volume ratio of fertilizer to water was 50:50 mg/ml), decompose for 36 days (at the temperature of 25-30° C. and the humidity of 30-50%), measure the mass of the loquat leaf litter before and after the deposition, and calculate the mass loss rate and the decomposition constant.

The results were shown in Table 3.

TABLE 3
Effects of Different Fertilizers on
Decomposition of Loquat Leaf Litter

| | | Mass | Decomposition |
|---|---|---|---|
| Group | Treatment method | loss rate | constant |
| Experimental | Applying nitrogen fertilizer | 15.97% | 0.0045 |
| Group 4 | | | |
| Experimental | Applying phosphate fertilizer | 9.84% | 0.0029 |
| Group 5 | | | |
| Experimental | Applying trace element fertilizer | 5.44% | 0.0015 |
| Group 6 | | | |
| Control | Applying water | 7.19% | 0.0026 |
| Group 1 | | | |

The results showed that the mass loss rate and the decomposition constant in the experimental group 4 were the highest compared with the control group 1. That is: the solution of applying the nitrogen fertilizer on the surface of the loquat leaf litter in the experimental group 4 could promote the decomposition of the loquat leaf litter. Wherein the mass loss rate was increased by 8.78% compared with the control group 1.

To sum up, the decomposition of the loquat leaf litter could be significantly promoted by applying the nitrogen fertilizer to the loquat leaf litter and decomposing for 36 days.

### Embodiment 4

Effects of added Pseudomonas solution on decomposition of loquat leaf litter under different temperatures and humidities

Pseudomonas solution was dissolved in pure water at a ratio of 1 ml of bacterial solution to 1 L of water to obtain diluted bacterial solution. According to the concentration of 10 ml of diluted bacterial solution per 1 kg of litter, under three constant temperatures and humidities, the Pseudomonas solution (diluted) was added separately to the surface of the loquat leaf litter for decomposing for 60 days. The mass of the loquat leaf litter before and after decomposition was measured, and the mass loss rate and the decomposition constant were calculated.

The results were shown in Table 4.

TABLE 4
Effects of Pseudomonas Solution on Decomposition of Loquat
Leaf Litter Under Different Temperatures and Humidities

| | | | Mass | |
|---|---|---|---|---|
| | Components | Temperature | loss | Decomposition |
| Group | applied | and humidity | rate | constant |
| Experimental | Pseudomonas | 35° C., 75% | 26.7% | 0.0052 |
| Group 7 | solution | | | |
| Experimental | Pseudomonas | 25° C., 80% | 23.1% | 0.0044 |
| Group 8 | solution | | | |
| Experimental | Pseudomonas | 14° C., 68% | 17.0% | 0.0031 |
| Group 9 | solution | | | |
| Control | Distilled water | 35° C., 75% | 12.0% | 0.0021 |
| Group 1 | | | | |
| Control | Distilled water | 25° C., 80% | 11.2% | 0.0020 |
| Group 2 | | | | |
| Control | Distilled water | 14° C., 68% | 10.7% | 0.0019 |
| Group 3 | | | | |

The results showed that the mass loss rate and the decomposition constant of the loquat leaf litter were increased by applying the Pseudomonas solution to the surface of the loquat leaf litter under three temperatures and humidities. The decomposition of the loquat leaf litter could be significantly promoted by applying the Pseudomonas solution to the loquat leaf litter and decomposing for 60 days.

### Embodiment 5

Effects of different combinations of mixed solutions of laccase, lignin peroxidase and leucine aminopeptidase on the decomposition of loquat leaf litter at natural temperature in the field environment

The loquat leaf litter was decomposed for 150 days in the natural environment (a daytime temperature of 15±5° C., with a humidity of 75±5%; a nighttime temperature of 5±3° C., with a humidity of 40±5%), to verify the effect of the mixed enzyme solution on promoting decomposition. (The concentration was still 10 mg/g litter, and each enzyme is 10 mg, that is, taking experimental group 10 as an example, the three enzymes were added with 10 mg/g litter). The mass of the loquat leaf litter before and after decomposition was measured, and the mass loss rate and the decomposition constant were calculated.

The results were shown in Table 5.

TABLE 5
Effects of Mixed Enzyme on Decomposition of Loquat Leaf Litter

| | | Mass | |
|---|---|---|---|
| | | loss | |
| | | rate | Decomposition |
| Group | Solution added | (%) | constant |
| Experimental | Mixed solution of laccase + | 24.78 | 0.0019 |
| Group 10 | lignin peroxidase + leucine | | |
| | aminopeptidase | | |
| Experimental | Mixed solution of laccase + | 22.37 | 0.0017 |
| Group 11 | leucine aminopeptidase | | |
| Experimental | Mixed solution of lignin | 23.25 | 0.0018 |
| Group 12 | peroxidase + leucine | | |
| | aminopeptidase | | |
| Experimental | Mixed solution of laccase + | 25.44 | 0.0020 |
| Group 13 | lignin peroxidase | | |
| Control | Water | 21.49 | 0.0016 |
| Group 1 | | | |

The results showed that when the loquat leaf litter in the experimental groups 10-13 was decomposed in situ to 150 days in the natural environment, the mass loss rates and the decomposition constants thereof were higher than those in the control group 1. It showed that the experimental groups 10-13 had the effect in promoting the decomposition of the loquat leaf litter. After decomposing for 150 days according to the technical solution, the mass loss rate was increased from 21.49% to 22.37%-25.44%, and the decomposition constant was increased from 0.0016 to 0.0017-0.0020. Wherein the experimental group 13 (spraying the mixed solution of laccase and lignin peroxidase) had the best promotion effect. The above results showed that the decomposition of the loquat leaf litter could also be promoted by spraying the mixed solution of laccase, lignin peroxidase and leucine aminopeptidase thereon in the natural environment.

In an indoor single enzyme test, leucine aminopeptidase and lignin peroxidase had the best comprehensive effect. Meanwhile, considering that laccase and lignin peroxidase had similar effects, i.e., degrading lignin in the litter, one of them was selected to continue the test.

Comprehensive analysis of the results of embodiments 2-5 was conducted to select the nitrogen fertilizer, leucine aminopeptidase, lignin peroxidase, and Pseudomonas solution that promote the decomposition of the loquat leaf litter, and to design different concentrations and combinations of experiments in order to select the best combination and ratio.

### Embodiment 6

1. The air-dried, intact and uncorrupted loquat leaf litter was collected from the loquat orchard in Dongshan Town, Wuzhong District, Suzhou City, Jiangsu Province, and 15 g of loquat leaf litter was weighed, put into a decomposition bag and put back in its original position. Three decomposition bags were placed as parallel samples in each embodiment.

2. According to the proportions in Table 6, 750 mg of nitrogen fertilizer, 75 mg of lignin peroxidase and 225 mg of leucine aminopeptidase were weighed, mixed and dissolved in 900 mL of water. The mixed solution was evenly sprayed on the surface of the loquat leaf litter.

3. Pseudomonas solution was dissolved in pure water at a ratio of 1 ml of bacterial solution to 1 L of water for dilution, and 0.15 ml of diluted bacterial solution was sprayed on the surface of the loquat leaf litter according to Table 6. (Because the volume of the bacterial solution is too small, 0.15 ml of diluted bacterial solution could be dissolved in 100 ml of water again during operation so that it could be sprayed evenly on the litter surface).

4. The loquat leaf litter was decomposed for 120 days in the natural environment (a daytime temperature of 15±5° C., with a humidity of 75±5%; a nighttime temperature of 5±3° C., with a humidity of 40±5%), taken out of the decomposition bag, and weighed after removing the soil attached on the surface. The decomposition constant and the mass loss rate were calculated. The results were shown in Table 7.

### Embodiments 7-14

The embodiments have the same steps as embodiment 6 except for the concentrations of sprayed components in step 2 and step 3 (refer to Table 6). The decomposition time is 120 days. The results of the decomposition constant and the mass loss rate of loquat leaf litter were shown in Table 7.

### Control Example 1

The control example has the same steps as embodiment 6 except for water sprayed on the surface of the loquat leaf litter in step 2 and step 3. The decomposition time is 120 days. The results of the decomposition constant and the mass loss rate of loquat leaf litter were shown in Table 7.

TABLE 6
Proportion in Embodiments and Control Example

| | Nitrogen | Leucine | Lignin | Pseudomonas |
|---|---|---|---|---|
| | fertilizer | amino- | peroxidase | solution |
| | mg/g | peptidase | mg/g | ml/kg |
| | litter | mg/g litter | litter | litter |
| Embodiment 6 | 50 | 15 | 5 | 10 |
| Embodiment 7 | 0 | 10 | 15 | 10 |
| Embodiment 8 | 50 | 5 | 15 | 15 |
| Embodiment 9 | 25 | 5 | 10 | 10 |
| Embodiment 10 | 25 | 15 | 15 | 5 |
| Embodiment 11 | 0 | 5 | 5 | 5 |
| Embodiment 12 | 0 | 15 | 10 | 15 |
| Embodiment 13 | 25 | 10 | 5 | 15 |
| Embodiment 14 | 50 | 10 | 10 | 5 |
| Control | 0 | 0 | 0 | 0 |
| example 1 | | | | |

TABLE 7
Test Results of Embodiments and Control Example

| | Mass loss rate | Decomposition constant |
|---|---|---|
| Embodiment 6 | 42.7% | 0.0047 |
| Embodiment 7 | 48.7% | 0.0056 |
| Embodiment 8 | 39.2% | 0.0043 |
| Embodiment 9 | 43.3% | 0.0048 |
| Embodiment 10 | 41.7% | 0.0046 |
| Embodiment 11 | 50.7% | 0.0059 |
| Embodiment 12 | 43.3% | 0.0051 |
| Embodiment 13 | 40.0% | 0.0043 |
| Embodiment 14 | 38.0% | 0.0040 |
| Control example 1 | 30.0% | 0.0030 |

When the loquat leaf litter in the embodiments 6-14 was decomposed to 18 days, the mass loss rates and decomposition rate constants were higher than those in the control example 1. It showed that the embodiments 6-14 had the effect in promoting the decomposition of the loquat leaf litter. After decomposing for 120 days according to the technical solution, the mass loss rate was increased from 30.0% to 38.0%-50.7%, and the decomposition constant was increased from 0.0030 to 0.0040-0.0059. Wherein embodiments 7 and 11 had the best promotion effect.

The above results show that the decomposition of the loquat leaf litter can be promoted by spraying the mixed solution of nitrogen fertilizer, Pseudomonas, lignin peroxidase, and leucine aminopeptidase thereto in the natural environment. Different proportions have different promotion effects. Considering the cost, embodiment 11 (no nitrogen fertilizer is used, and the concentrations of enzyme and bacteria are 5 mg of enzyme per gram of litter and 5 ml of bacterial solution per kilogram of litter, respectively) has the best comprehensive effect.

It can be seen from the above embodiments that the technical solution of the present invention can increase the mass loss rate of the loquat leaf litter (by 8%-20.7%), and effectively promote the decomposition of the loquat leaf litter.

Each embodiment in the description is described in a progressive way. The difference of each embodiment from each other is the focus of explanation. The same and similar parts among all of the embodiments can be referred to each other.

The above description of the disclosed embodiments enables those skilled in the art to realize or use the present invention. Many modifications to these embodiments will be apparent to those skilled in the art. The general principle defined herein can be realized in other embodiments without departing from the spirit or scope of the present invention. Therefore, the present invention will not be limited to these embodiments shown herein, but will conform to the widest scope consistent with the principle and novel features disclosed herein.

What is claimed is:

1. A complexing agent for promoting decomposition of loquat leaf litter, comprising leucine aminopeptidase, lignin peroxidase, and Pseudomonas solution, wherein a mass-to-volume ratio of the leucine aminopeptidase, the lignin peroxidase, and the Pseudomonas solution is 5 kg: 5 kg: 5 ml.

2. The complexing agent according to claim 1, wherein the enzyme activity of the leucine aminopeptidase and the lignin peroxidase is greater than or equal to 20 units/mg.
